(19) United States
(12) Patent Application Publication
(10) Pub. No.: US 2026/0320195 A1
(43) Pub. Date: Oct. 15, 2026

(54) SECURITY ABSTRACTION LAYER FOR MANAGING SOFTWARE DEPLOYMENTS

(71) Applicant: BBY SOLUTIONS, INC., Richfield, MN (US)

(72) Inventors: Eray Alemdar, Mound, MN (US); Matthew Steven Hurewitz, Minnetonka, MN (US); Usuf Nasir Khan, Columbus, OH (US)

(21) Appl. No.: 19/178,696

(22) Filed: Apr. 14, 2025

(51) Int. Cl. G06F 21/57; G06F 8/77

(52) U.S. Cl. CPC G06F 21/577; G06F 8/77; G06F 2221/033

(57) ABSTRACT

A security abstraction layer platform to integrate and monitor the use of security tools in code development processes and environments is disclosed. An example method for implementing a security abstraction layer platform for integration with a software development process includes: establishing security tool configurations that integrate multiple security tools for vulnerability identification in a software development project; operating an orchestrator to manage security scans performed by the multiple security tools on source code of the software development project; collecting aggregated results from the security scans performed by the multiple security tools; and outputting the aggregated results from the security scans in a graphical user interface, to identify code vulnerabilities identified by the security scans.

### TECHNICAL FIELD

Embodiments discussed herein generally relate to security and software development technologies deployed in computing systems. Certain embodiments discussed herein relate to approaches that enable the integration and orchestration of security tooling into software development environments.

### BACKGROUND

A variety of approaches are used during software development processes to ensure the security and reliability of code and the resulting software products. Organizations may choose to use a variety of security tools that perform assessments on code and compiled software binaries, run scans for known vulnerabilities, and continually monitor the code set for new vulnerabilities. These security tools are often provided by many different vendors, so the use of different security tools may require time-consuming and resource-intensive integration with different code development environments.

Each security tool may need a specific configuration to work with a code development project, so additions or changes to the security tools will often result in corresponding adjustments to the configurations needed to scan the code and/or binaries. The entire process of deploying and configuring security tooling can lead to a significant drain on software development resources, especially when developing ongoing software releases and updates in a continuous integration (CI) and continuous delivery (CD) pipeline.

Additionally, a manual process is often used to evaluate the results of identified vulnerabilities and issues from multiple security tools. A manual process may lead to out-of-date information, which will typically not provide a real-time view of security risks. The manual aggregation of vulnerabilities and the overall patchwork of security tools may hinder an organization’s ability to quickly assess and prioritize security issues, leaving organizations with a fragmented view of their security posture.

### BRIEF DESCRIPTION OF THE DRAWINGS

FIG. 1 illustrates example scenarios for software development, according to an example.

FIG. 2 illustrates an integration of a security abstraction layer platform into a code development and deployment process for an enterprise, according to an example.

FIG. 3 illustrates a listing of functions for a security abstraction layer platform, according to an example.

FIG. 4 illustrates a graphical user interface for the configuration of projects established within a security abstraction layer platform, according to an example.

FIG. 5 illustrates a graphical user interface for the evaluation of projects configured within a security abstraction layer platform, according to an example.

FIG. 6 illustrates another graphical user interface for the evaluation of projects configured within a security abstraction layer platform, according to an example.

FIG. 7 illustrates a graphical user interface for the evaluation of vulnerabilities in a particular project configured within a security abstraction layer platform, according to an example.

FIG. 8 illustrates a graphical user interface for the evaluation of vulnerabilities tracked by a security abstraction layer platform, according to an example.

FIG. 9 illustrates a data flow for the use of security tools and the creation of a machine learning model within a security abstraction layer platform, according to an example.

FIG. 10 illustrates a flowchart of a method of implementing a security abstraction layer platform for integration with a software development process, according to an example.

FIG. 11 illustrates a block diagram of computing system components for implementing a security abstraction layer platform for use with security tools, according to an example.

FIG. 12 illustrates a block diagram of operational components of a computing system upon which any one or more of the techniques herein discussed may be executed and implemented.

### DETAILED DESCRIPTION

The following description and drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The examples discussed herein are directed to features and logic provided within a security tooling platform. This platform, referred to as a “Security Abstraction Layer” or “SAL”, is a software environment that integrates the use of multiple security tools into multiple code development environments. The SAL platform can coordinate security operations that are not dependent on specific tool configurations or specific code integrations, to enable straightforward use of tools and functions provided by different vendors. Further, the SAL platform allows these tools and functions to be integrated into different types and scenarios of software development projects.

The SAL platform can help ensure code trustworthiness by coordinating and consolidating security scans among multiple security tools, without requiring the use of a dedicated vendor tool ecosystem. The SAL platform also automates the detection and configuration of required security scans and security tool operations, while supporting the automatic discovery of infrastructure components and the onboarding of new security applications. The SAL platform includes orchestration and configuration capabilities for multiple types of tools while prioritizing the discovery of certain vulnerabilities.

Thus, the SAL platform addresses many of the technical challenges of implementing and maintaining security tools in CI/CD code development processes by using a common platform to orchestrate security scans, maintain security configurations, and automate vulnerability workflows and reporting. The SAL platform also provides self-service and automation components that can significantly reduce the time and technical effort for deploying and maintaining (e.g., adding and updating) the security tools. Once the SAL platform is integrated with a software development environment, it enables the seamless addition of new security tools into software application code development projects without interrupting development teams. Consistency is ensured across software development environments, real-time feedback is collected, and vulnerability reporting is aggregated.

As will be understood, CI software development refers to the practice of integrating code changes from multiple contributors into a developed software product. Security tools can be used to scan for vulnerabilities directly in the source code, so that developers can perform security checks and validations as code is newly designed in the CI/CD pipeline. CI security tools can help ensure that security vulnerabilities are identified and fixed early in the development process, reducing the chances of deploying insecure code and applications. In conventional approaches, each CI security tool would require individual integration with a development team’s build pipeline and processes, which is time-consuming and resource-intensive. The SAL platform overcomes this technical challenge by serving as a centralized platform that abstracts security configurations from different application deployments and development teams, allowing for a single integration point for security tooling. This ensures that security configurations are consistent across many environments to reduce the risk of misconfiguration, which can lead to inaccurate scan results or missed vulnerabilities. After security tools are integrated among different software application deployments, the SAL platform can then orchestrate scans from multiple security tools through a unified interface. This can optimize the time to deploy the security tools while offering new developer functionality through automation and self-service capabilities. Further, the SAL platform can enable developers and administrative users to easily add or swap in security tools without significant disruption to the CI development process or software releases.

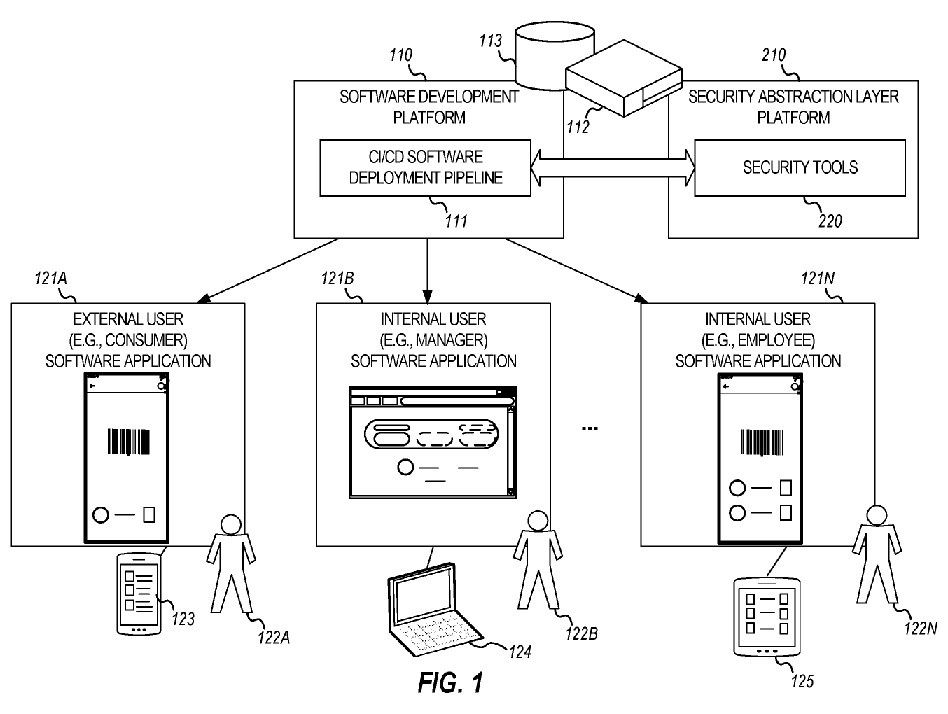

FIG. 1 illustrates an overview of a scenario for deploying software applications. Here, this scenario shows a software development ecosystem that incorporates a security abstraction layer platform 210 to enhance the security of software applications during the software development and deployment process. A software development platform 110 (shown as a single platform, but which may include many different interfaces and instances) provides an environment where the source code for various software applications is developed, tested, and verified. This may involve a variety of user interfaces, integrated development environments, testing environments, and other development tooling (not shown).

This software development platform 110 hosts a CI/CD software deployment pipeline 111 for developing respective software applications, with functions that automate the integration of new code and code changes and deploy the code to staging and production environments. The CI/CD software deployment pipeline 111 ensures that software applications can be continuously updated and delivered for different use cases. For instance, in an enterprise setting, the software development platform 110 may be used to create software applications that are deployed to external users, such as consumers 122A, and to internal users, such as managers 122B and employees 122N. The corresponding software applications are represented as external user software application 121A, internal user software application 121B, and internal user software application 121N.

Users may directly or indirectly interact with the software applications through various devices, such as a mobile device 123, a personal computer 124, and a tablet 125. Although user-facing software applications are depicted, other types of software applications such as internal services may also be deployed, and each software application can be tailored to meet the specific needs of the use case. Relevant software application types may include web apps, mobile apps, enterprise services, microservices, and back-end applications in a variety of user and non-user-facing components. Thus, it will be understood that the software applications may be accessed and function across many different settings, environments, and use cases.

In this setting, the security abstraction layer platform 210 interfaces with the CI/CD software deployment pipeline 111 to improve the security of the software development process and deployed code. The security abstraction layer platform 210 uses various security tools 220 that scan the software application code for vulnerabilities before and during deployment. The security abstraction layer platform 210 acts as an intermediary middleware layer, abstracting the complexities of deploying and integrating the individual security tools, while providing a unified interface for managing scans and vulnerability detection from the multiple security tools. The security abstraction layer platform 210 enables the seamless integration of security tools and security measures without disrupting the development workflow of the CI/CD software deployment pipeline 111.

The security abstraction layer platform 210 may be operated on a computer system, such as a server 112 with a connected database 113. This system provides a computing infrastructure for storing and processing data related to the software applications and their development, and for configuring, deploying, and using the security tools 220. The database 113, for example, can store configuration data, scan results, and other relevant information related to the security tooling while the server 112 executes the computational tasks required for running or orchestrating the security tools and the security scans. Although only one server 112 and database 113 are shown, it will be understood that multiple servers and databases, including distributed (e.g., cloud-implemented) implementations of the servers and databases, may be provided.

The integration of the security abstraction layer platform 210 with the software development platform 110 and the CI/CD software deployment pipeline 111 provides a number of technical benefits for improving the security and reliability of software applications. By automating security scans and providing a centralized management interface, the security abstraction layer platform 210 enhances the security posture of software while maintaining the efficiency and agility of the CI/CD development process and developer autonomy.

Security tools that perform static code analysis, software composition analysis, and protected information scanning are recommended to be run during the build stage, so that developers can obtain early feedback on possible security vulnerabilities and remedy the vulnerabilities as the code is developed. However, this means that the security tool configurations that are used by different security tools to run the scans need to be implemented in the code development and build tools themselves. In an organization that deploys hundreds or thousands of applications, it can be a very tedious process to configure and aggregate results from many security tools. As a result, the configuration of individual security tools and the aggregation of risks and vulnerabilities from the individual security tools are often performed manually (and possibly in an incomplete manner) and not in real time.

An organization might use multiple security tools to perform assessments, run scans to find vulnerabilities, monitor for security threats and vulnerabilities, and run and audit assessments to meet compliance requirements. Conventionally, each of these scans, assessments, and monitoring would be performed by tools offered by different vendors, and with different combinations of tools integrated into different software development platforms. Thus, with conventional approaches, organizations often would need to manually map and track the use of security tools for different software applications and development projects. Even if multiple security tools are integrated into a CI/CD software deployment pipeline, most types of security tools require some manual change to the security configurations used in the software build environment when the vendors of such tools deploy software upgrades. As a result, it is a significant challenge to map developed software applications to security tools and products provided by different software vendors. These and other technical limitations are overcome with the following functions of the security abstraction layer platform 210.

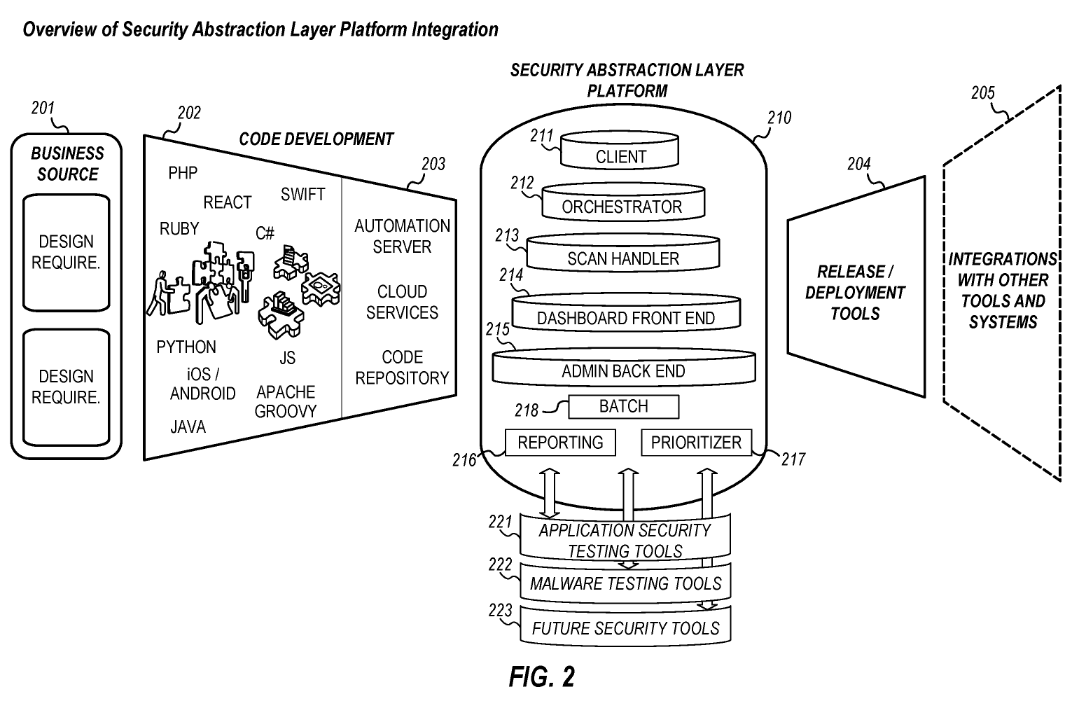

FIG. 2 depicts an example overview of the functions of the security abstraction layer platform 210. Here, the security abstraction layer platform 210 includes administrative back-end functions 215, front-end functions 214 (e.g., user interfaces and application programming interfaces), and other functional components such as a batch component 218, a prioritizer component 217, a reporting component 216, a scan handler 213, an orchestrator 212, and a client 211. The security abstraction layer platform 210 coordinates these functional components for orchestrating security scans, organizing security tool configurations, and managing security notifications and reporting.

For instance, consider a scenario where a business source 201 provides various software designs and functionality for software development projects based on user needs and design requirements. A CI code development process may be implemented using any number of programming languages 202 such as PHP, React, Swift, Ruby, C#, Python, JavaScript, Apache Groovy, iOS/Android, Java, and code development services 203 such as automation servers, cloud services, and code repositories. As the software components are developed, they will be released via release and deployment tools 204 and integrated with other tools and systems 205. Here, the security abstraction layer platform 210 serves as a bridge between code development and release/deployment phases, to directly utilize various security tools 221, 222, and 223 in the code development phase, before release and deployment.

The security abstraction layer platform 210 establishes configurations that enable respective code development projects for software applications to use application security testing tools 221, malware testing tools 222, and other types of security tools 223 (including future tools not yet integrated or deployed). The security abstraction layer platform 210 supports onboarding applications for security testing without developer involvement, while automating vulnerability tracking from the security tools 221, 222, and 223.

The security abstraction layer platform 210 can integrate with existing security tools and suites that perform any number of code analysis, vulnerability checking, and protected information checking, including, as a non-limiting example, tools from the Checkmarx™ security testing suite or the Sonatype™ application security suite. To interface with the security tools and suites, the security abstraction layer platform 210 may implement the following components via a combination of microservices and applications.

The SAL client 211 may be configured as a command line utility that orchestrates security scans between CI systems and the security testing tools orchestrated by the platform. The SAL client 211 assists with authenticating service accounts configured in CI tools for the security abstraction layer platform 210, obtaining configuration(s) for individual software development projects, generating the relevant artifacts such as source code and a software bill of materials (SBOM) according to the configuration(s), and providing the status of the security scans back to the CI systems. The SAL client 211 can also provide a uniform pipeline that development teams can use in their CI tools to orchestrate the security scans (e.g., during development).

The SAL orchestrator 212 is the engine responsible for orchestrating security scans among differently configured security tools. As noted, the SAL client 211 generates artifacts such as the source code and the SBOM to be run through the security tools, and the artifacts are passed to the SAL orchestrator 212. As an example, the SAL orchestrator 212 can retrieve a configuration associated with a particular software application and apply the configuration before orchestrating the security scans with different security tools configured for the particular software application. The SAL orchestrator 212 then waits for an acknowledgment from the security tools, and passes an application identifier and application metadata to a message queue.

To accelerate application onboarding, functionality can be provided in the security abstraction layer platform 210 so that application development teams can self-integrate a software application for review. Additionally, functionality can be provided so that if the security abstraction layer platform 210 does not find a configuration(s) for some identified application(s), then the application(s) can be queued for integration review.

The SAL scan handler 213 obtains messages from the message queue sent by the SAL orchestrator 212 and polls the security tools for the status of the scan. When a scan completes in each security tool, the SAL scan handler 213 obtains any vulnerability details and saves this information in a database for later use. The SAL scan handler 213 can also create tracking tickets in configured bug tracking tools or other tracking systems. The SAL scan handler 213 can also trigger or send out notifications to different channels (e.g., via email, collaboration groups, organization teams, etc.) as configured.

The SAL dashboard front-end functions 214 provide user interface views for admins and development teams to configure, manage, and use the security abstraction layer platform 210. These SAL dashboard front-end functions 214 provide various views of historical data and vulnerability tracking, enhancing compliance and release management. Additional examples of user interface views are discussed below.

The SAL admin back-end functions 215 provide application programming interfaces (APIs) to manage the operation of the security abstraction layer platform 210 and associated administration backend services. For instance, the SAL admin back-end functions 215 provide APIs to configure different security tools, provision user and service accounts for the security abstraction layer platform 210, configure the use of specific security tools into specific apps, identify configurations to be used by the security tools, configure notifications, and provide graphical support to query vulnerability data. The SAL admin back-end functions 215 can also provide control for onboarding apps, such as by providing APIs to automate gating of product deployments and reporting.

The SAL reporting component 216 is configured to create aggregated or individual reporting. Security managers, leadership, or other relevant administrative users can use the reporting functionality to execute complex queries that generate reporting on trends, outstanding vulnerabilities, and generate metrics.

The SAL batch component 218 is a batch app or service that is configured to perform scheduled tasks. The SAL batch component 218 can run multiple scheduled jobs in a specified interval.

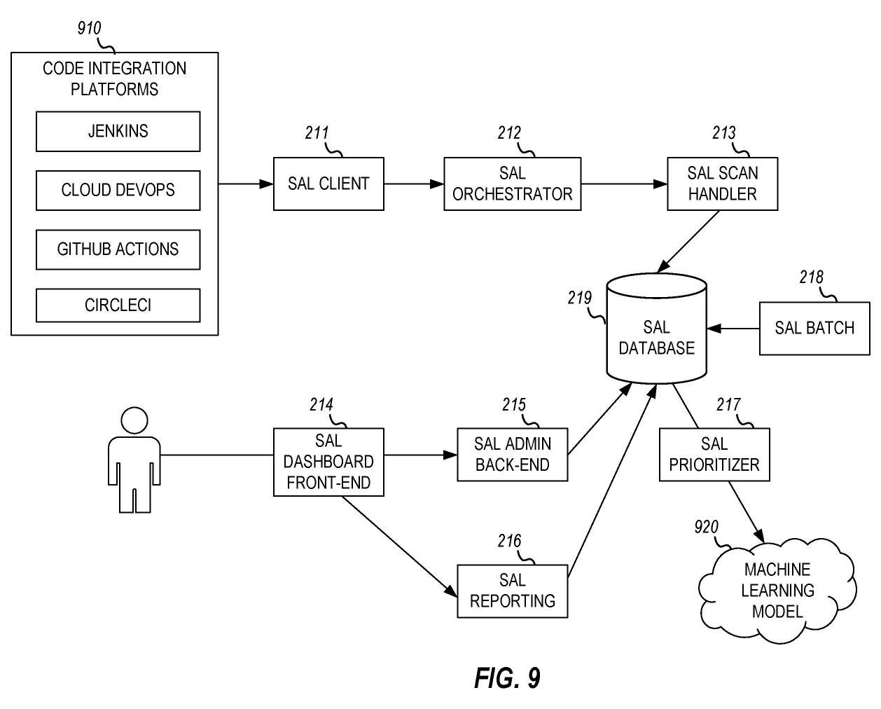

The SAL prioritizer component 217 applies artificial intelligence or machine learning techniques based on existing vulnerability data evaluated in a trained model. For instance, a trained model can be used to prioritize security scans or results of the scans (e.g., to prioritize certain vulnerabilities), such as categorizing vulnerabilities identified in a security scan by application type, vulnerability type, and vulnerability severity. Additional discussion of the SAL prioritizer component 217 is discussed below with reference to FIG. 9.

The security abstraction layer platform 210 thus provides many types of tool-agnostic functionality that can be used to automate security scans, abstract configurations, and aggregate vulnerability data for prioritization and alerts, to improve use of many different security tool types and suites. The security abstraction layer platform 210 reduces the time and effort required for integrating new security tools, ensuring consistency and real-time feedback across environments. The security abstraction layer platform 210 further enables real-time result aggregation and vulnerability prioritization, distinguishing the platform from existing approaches.

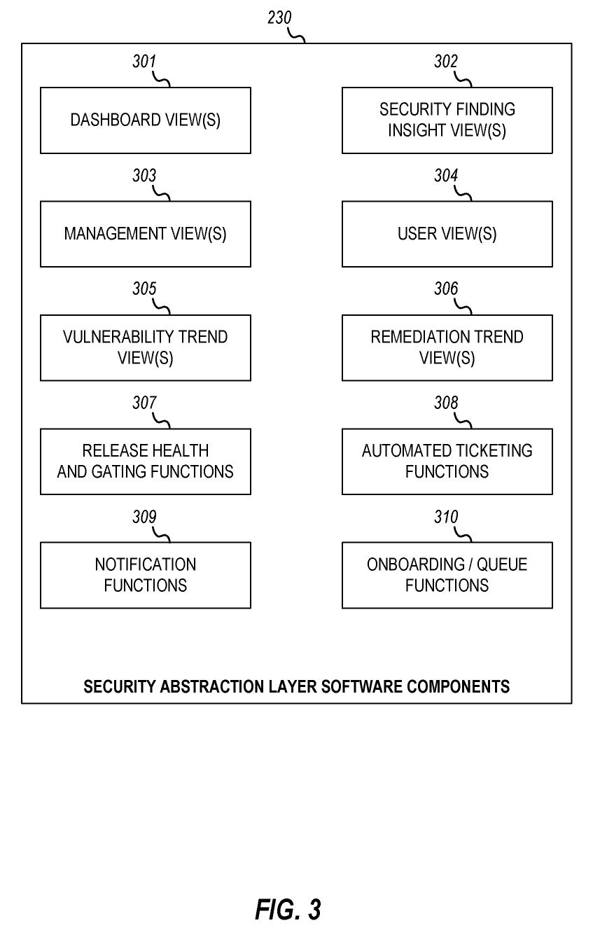

FIG. 3 illustrates additional software components 230 integrated into the security abstraction layer platform 210. In an example, these software components 230 include but are not limited to the following functions and outputs.

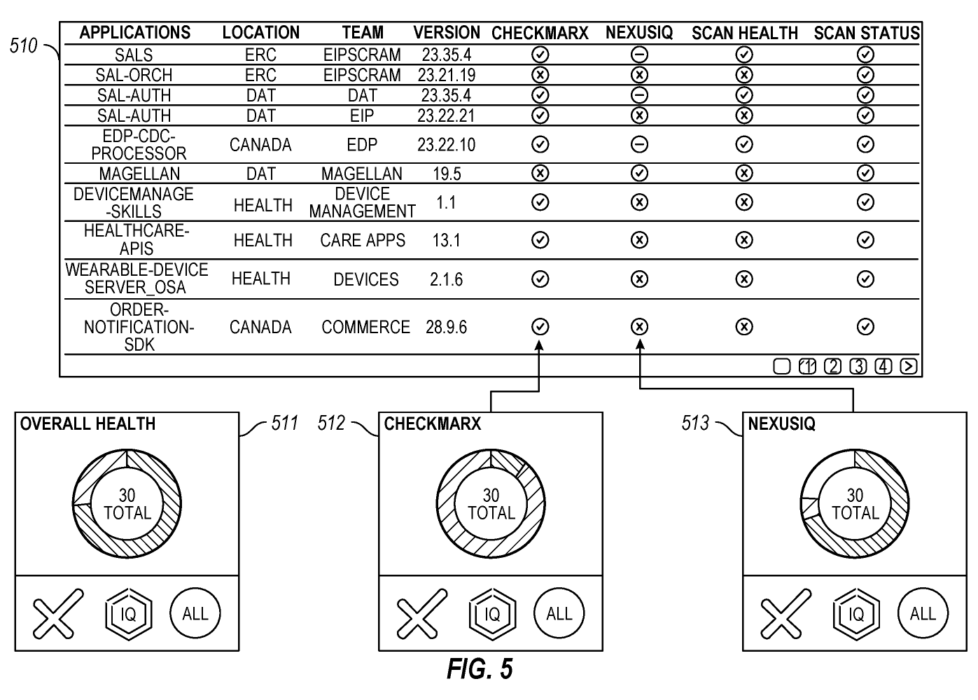

First, the security abstraction layer platform 210 includes a software component to generate dashboard views 301, offering multiple interfaces for users to interact with the security abstraction layer platform 210. For example, the dashboard views 301 may provide a graphical user interface that presents overviews and results from security operations, allowing users to monitor and manage security activities effectively. Examples of the dashboard views 301 in a graphical user interface are depicted in various examples of FIGS. 5 to 7.

The security abstraction layer platform 210 includes a software component to generate security finding insights views 302, which provides detailed analysis and interpretation of security scan results. The security finding insights views 302 assists users in understanding the implications of identified vulnerabilities and provides actionable insights to address security issues. The security finding insights views 302 can assist users with prioritizing remediation efforts and verifying that security measures and remediations are implemented. Examples of the security finding insights views 302 in a graphical user interface are depicted in various examples of FIGS. 5 to 7.

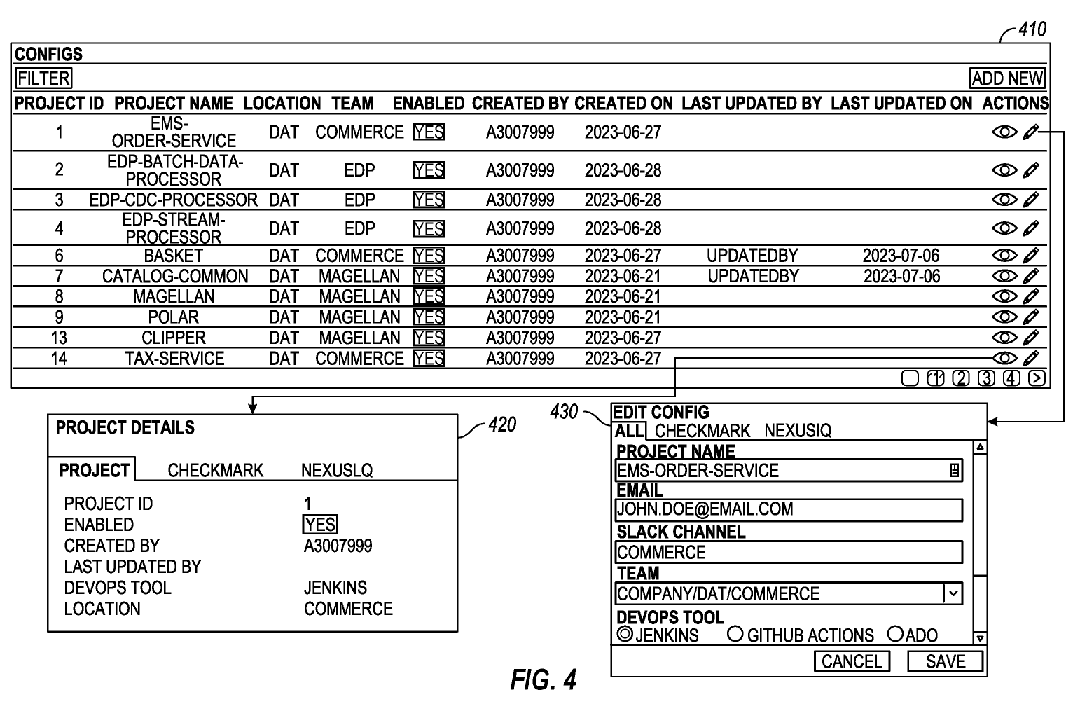

The security abstraction layer platform 210 includes a software component to generate management views 303, such as with an interface that provides a comprehensive overview of security operations for management and administrative users. These views 303, for example, may present aggregated data and metrics to assist in strategic decision-making and resource allocation for security operations and changes. Examples of the management views 303 in a graphical user interface are depicted in various examples of FIG. 4.

The security abstraction layer platform 210 includes a software component to generate user view(s) 304, such as in the form of personalized interfaces for different users interacting with the security abstraction layer platform 210. The security abstraction layer platform 210 tailors the information views and view functionalities available to users based on their roles and responsibilities, enhancing the user experience and ensuring that relevant data is accessible to the appropriate stakeholders. Examples of the user views 304 in a graphical user interface are depicted in various examples of FIG. 4 to 7.

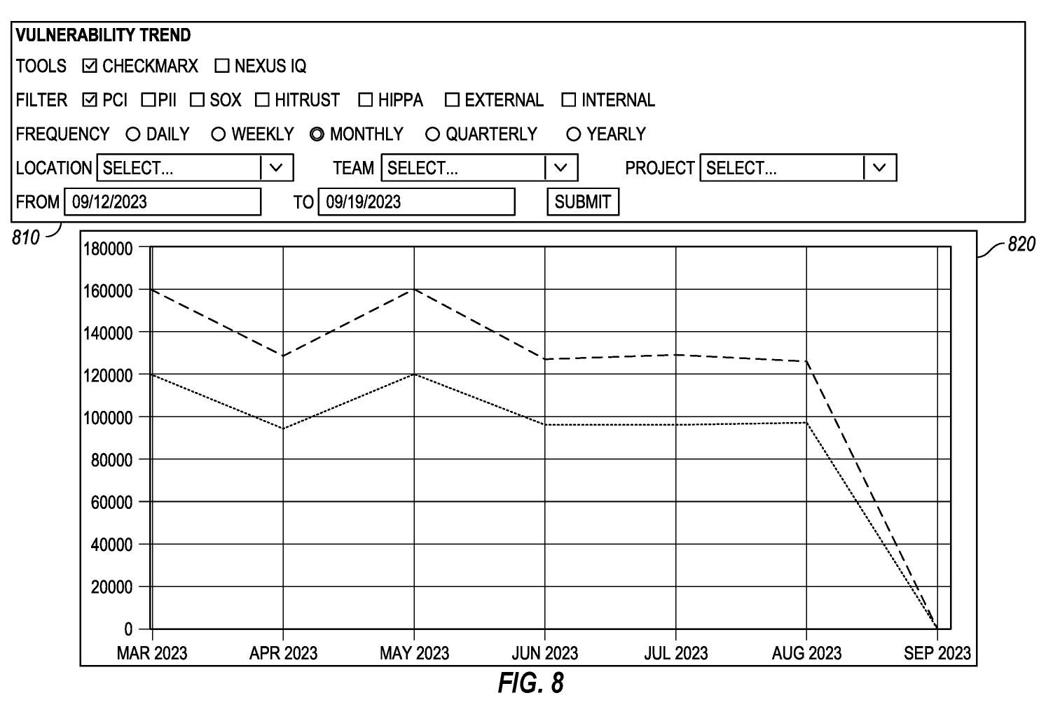

The security abstraction layer platform 210 includes a software component to generate vulnerability trend views 305, which provides historical data and trends related to identified vulnerabilities. This enables users to track the progress of vulnerability remediation efforts over time and assess the effectiveness of security measures. Examples of the vulnerability trend views 305 in a graphical user interface are depicted in the examples of FIG. 8.

The security abstraction layer platform 210 includes a software component to generate remediation trend views 306, used to monitor the progress and effectiveness of efforts to remediate vulnerabilities. This information offers insights into the speed and efficiency with which vulnerabilities are being managed, assisting organizations in refining their security processes and resource allocation. This view may be provided in a similar view as presented in the examples of FIG. 8.

The security abstraction layer platform 210 also includes release health and gating functions 307. For example, release health and gating functions 307 may be used to monitor the security status of software releases and determine whether the releases meet some necessary security criteria for deployment (or, gating if the releases do not meet the necessary security criteria). This can provide a checkpoint in the release process, ensuring that secure and compliant software is released to production environments.

The security abstraction layer platform 210 also includes automated ticketing functions 308, used to streamline the process of tracking and managing identified security issues. For instance, the automated ticketing functions can automatically generate tickets for identified vulnerabilities, assign these tickets to the appropriate teams, and track their resolution.

The security abstraction layer platform 210 also includes notification functions 309, used for alerting users to important security events and updates. The notification functions 309 can be used to inform relevant stakeholders of significant security issues in a timely manner. The notifications may be provided in a variety of formats and implementing software.

The security abstraction layer platform 210 also includes onboarding and queue functions 310, to manage the integration of new or updated software tooling into software development settings and configurations via the security abstraction layer platform 210. The process of adding or updating new security tools can reduce or eliminate a manual re-configuration effort from development teams.

In existing approaches, the use of security tool configurations (security configs) on the code build side can cause risks. The security configs can be inadvertently modified, because many build configs are written as code or configs and checked into the source control systems. There are risks of a developer inadvertently changing the security configs used to run scans or removing them entirely. This could prevent the scans from running, or even worse, run the scans with misconfigured security configs. Running security scans with misconfigured configs will provide inaccurate results while also providing organizations with a false sense of security. These risks can be reduced by the use of the security abstraction layer platform 210 to manage configurations and updates.

Additionally, many security tools may experience upgrades due to vendor updates. This can occur when vendors add more features, improve detection, or update rules, queries, and policies. As these upgrades are applied, the security scan configurations applied to the code development build may also need to change. Such configuration changes may need to be applied to many types of applications that run scans with the updated security tools. This information is difficult to track, but the failure to update the security configurations can expose software applications to ongoing security risks. Thus, in existing systems, even minor upgrades can result in extensive security and development team involvement. These issues can be handled by use of the security abstraction layer platform 210 to manage configurations and updates.

FIG. 4 illustrates an example graphical user interface 410 for the configuration of projects established within the security abstraction layer platform 210. Specifically, FIG. 4 shows how a centralized scan configuration management of multiple projects can be enabled within the graphical user interface 410.

The graphical user interface 410 enables security configurations to be verified and changed based on security requirements per application, without requiring application team engagement. Additionally, the graphical user interface 410 includes functionality to provide a project details view 420 and a configuration change view 430. Such views enable configuration changes to be immediately enacted per application. A security tool scan configuration can also be entered in advance for an application to accelerate onboarding.

FIG. 5 illustrates an example graphical user interface 510 for the evaluation of projects configured within the security abstraction layer platform 210. This graphical user interface 510 presents a first dashboard view that provides overall security health information for multiple security tools (e.g., shown with graphical indicator 511) or for individual security tools (e.g., shown with graphical indicator 512 and graphical indicator 513). The graphical user interface 510 may also provide other information relating to a current scan health, scan completion status, and onboarding status over multiple security tools or for individual security tools. Various interactive features can be presented to change the display and view of health information for different security tools and applications.

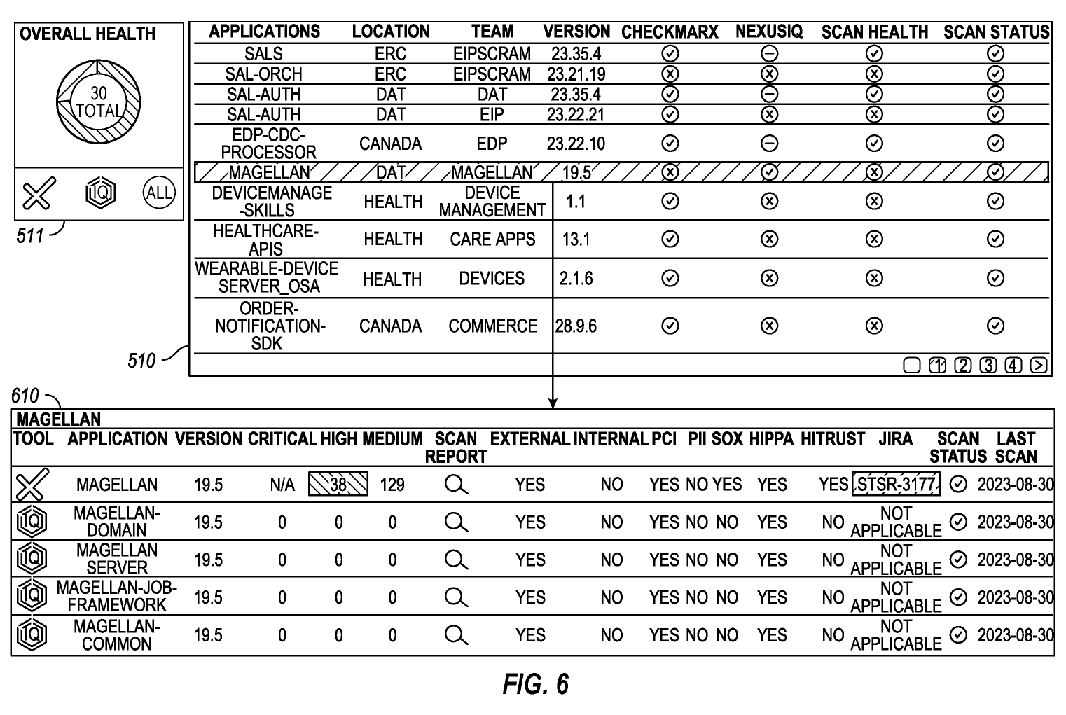

FIG. 6 illustrates another example graphical user interface 610 for the evaluation of projects configured within the security abstraction layer platform 210. Here, this graphical user interface 610 shows a detailed view of a particular software application project, with a listing of different security tools applied to different software applications within the software application project. This graphical user interface 610 includes a listing of different categories of vulnerabilities (e.g., critical, high, or medium), listings of different categories of security scanning (e.g., based on external or internal use, or based on protected information categories), and scan status information.

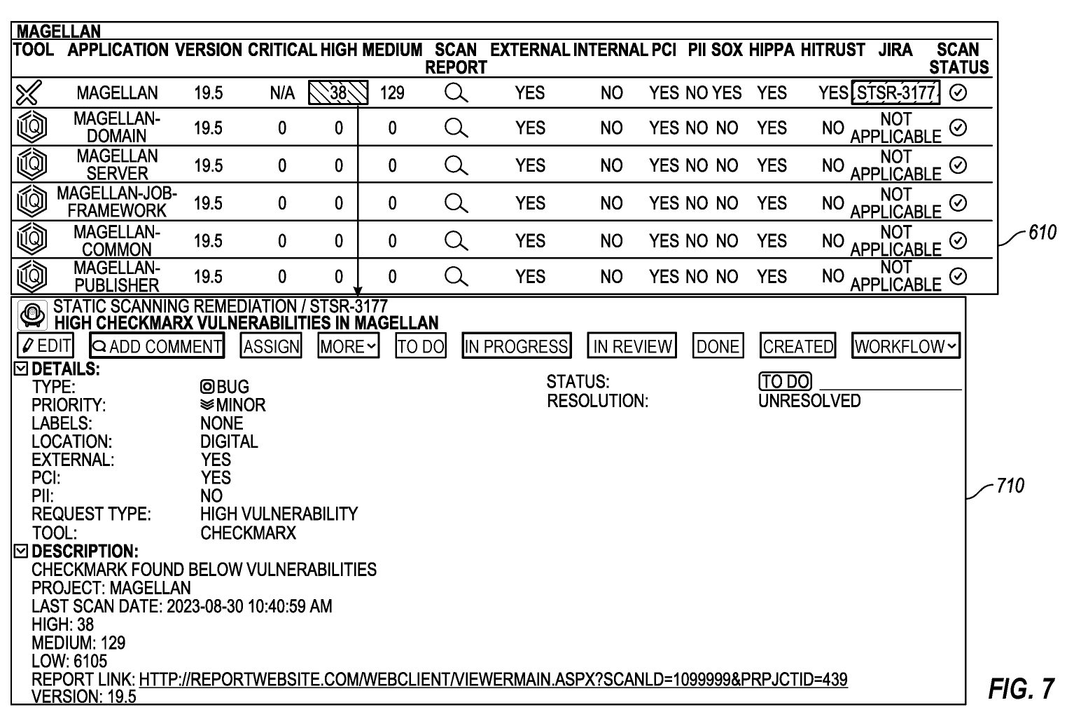

FIG. 7 illustrates another example graphical user interface 710 for the evaluation of vulnerabilities in a particular project configured within a security abstraction layer platform. Here, this graphical user interface 710 shows a detailed view of a software application within a defined project, with details on vulnerabilities identified in a high category. Application development and integration teams can use the information in the graphical user interface 710 to track overall vulnerability detection and remediation efforts for individual projects and software applications.

In some examples, the security abstraction layer platform 210 can automatically create a task or remediation ticket (e.g., a Jira ticket in a Jira ticketing system) when certain types of vulnerabilities are found. Such tickets can be reviewed and assigned to application teams based on automation, defined rules, or user oversight. In further examples, the security abstraction layer platform 210 can manage and automatically update ticket details after each scan, and the security abstraction layer platform 210 can update and automatically close a particular ticket after a remediation is completed for the identified issue.

FIG. 8 illustrates an example graphical user interface 820 for the evaluation of vulnerabilities tracked by a security abstraction layer platform, and an accompanying control graphical user interface 810. This graphical user interface 820 can depict a vulnerability trend in a graph, over time, based on some measurement of selected types of vulnerabilities or identified security issues. For instance, different types of vulnerabilities or security issues may be selected by a user for filtering via the control graphical user interface 810. Remediation trend tracking (e.g., to show how many issues have been remediated or resolved) may be presented in a similar graph or graphical user interface.

As referenced above, a number of functional aspects or features may be coordinated within the security abstraction layer platform 210 to manage changed configurations and the usage of various security tools. FIG. 9 illustrates an example data flow among components of the security abstraction layer platform 210 for an example scenario of performing security scans in a software development project using multiple security tools.

First, the data flow depicts how different code integration platforms 910 provide and obtain information with the SAL client 211. For example, the different code integration platforms 910 may include Jenkins, Azure DevOps, GitHub Actions, and CircleCI, among many others. These platforms are responsible for integrating code changes and providing information for initiating the security scanning process.

The SAL client 211 interfaces with these platforms to begin and manage the security scans on the relevant artifacts such as source code. The SAL client 211 functions as a bridge, ensuring that the necessary security configurations are applied and that the code is prepared for scanning.

The SAL orchestrator 212 receives the prepared code from the SAL client 211. The SAL orchestrator 212 is responsible for managing the execution of security scans with various security tools among the different code integration platforms 910. The SAL orchestrator 212 then coordinates the scanning process, ensuring that each security tool is utilized effectively and that the scans are conducted according to the defined security configurations.

Once the scans are initiated, the SAL scan handler 213 is used to collect vulnerability results and other scan information from the respective security tools. The SAL scan handler 213 monitors the progress of the scans and collects the aggregated scanning results from the multiple security tools.

The SAL scan handler 213 then saves the aggregated scanning results into the SAL database 219. The SAL database 219 serves as a central repository for storing scan results, configuration information, and other relevant data.

The SAL admin back-end functions 215 are used to interact with the database 219 to manage configurations, identify user accounts and projects, and manage administrative tasks for the security abstraction layer platform 210. The SAL dashboard front-end functions 214 are used to provide a user interface for interacting with the security abstraction layer platform 210. As discussed above, graphical user interfaces can enable users to view scan results, manage configurations, and access other functionalities provided by the platform. Such dashboards can be used to offer a comprehensive view of the security state of the software development projects and the results from one or multiple security tools.

The SAL reporting component 216 generates reports or compilations of data based on the data stored in the SAL database 219. The SAL reporting component 216 can be used to obtain insights into the security status of the projects, and highlight vulnerabilities and other important information on security status. These reports can be used for automated or human-directed decision-making and the prioritization of remediation efforts.

The SAL prioritizer component 217 utilizes a Machine Learning Model 920 to assess and prioritize vulnerabilities. By analyzing the security scan results, the SAL prioritizer component 217 determines the severity and impact of each vulnerability, allowing organizations to focus on the most significant security issues. This component enhances the efficiency of the security remediation process by providing data-driven insights and presenting these insights via data output (e.g., in a graphical user interface).

The SAL batch component 218 performs scheduled tasks, such as data backups and maintenance actions for the security abstraction layer platform 210. The SAL batch component 218 ensures that data collected within the security abstraction layer platform 210 operates efficiently and that data is updated and maintained.

Based on these features, the security abstraction layer platform 210 functions as a tool- and vendor-agnostic platform, seamlessly integrating with various security tools without requiring repeated integration efforts from development teams. Unlike existing approaches, the security abstraction layer platform 210 orchestrates security scans across multiple tools, aggregates vulnerability data in real time, and automates the configuration and management of security settings. The security abstraction layer platform 210 not only abstracts security configurations away from development teams but also provides a single, comprehensive security view per application, enhancing the developer experience through self-service and automation. Furthermore, the capability of real-time vulnerability prioritization and reporting, combined with the ability to evolve security capabilities without impacting engineering teams, distinguishes this platform from third-party products that lack real-time orchestration and integration flexibility.

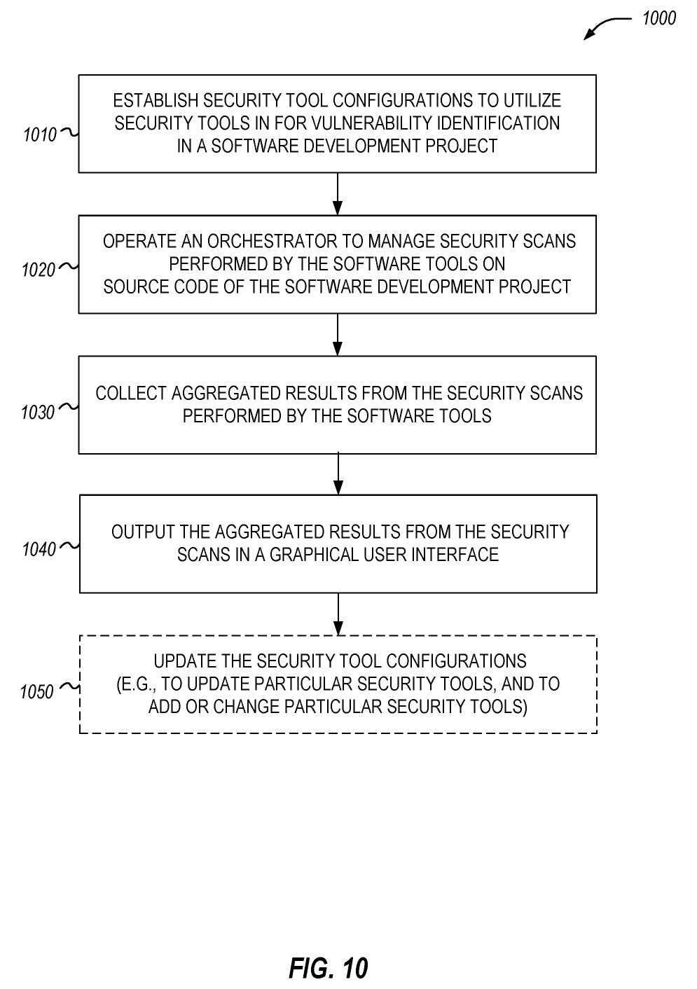

FIG. 10 illustrates a flowchart 1000 of an example method for implementing a security abstraction layer platform for integration with a software development process. In the flowchart 1000, the security abstraction layer platform is used for monitoring a particular software development project. However, this particular software development project may be one of multiple software development projects managed in the security abstraction layer platform. Consistent with the examples above, various characteristics of a single software development project or multiple software development projects can be identified and output with use of the security abstraction layer platform (including, with integration in a graphical user interface).

As shown, the flowchart 1000 begins with operation 1010 to establish security tool configurations that integrate multiple security tools into a software development project. Such security tool configurations can include configuration details that enable the use of a respective security tool to evaluate a corresponding aspect of the software development project, and perform vulnerability scanning and identification of the corresponding aspect of the software development project.

In some examples, the security abstraction layer platform may identify that a particular security tool of the multiple security tools does not have a corresponding security tool configuration for the software development project. The security abstraction layer platform may establish a configuration for this particular security tool, and update the security tool configurations to include the particular security tool.

The flowchart 1000 continues with operation 1020 to operate an orchestrator that manages security scans performed by the multiple software tools on the software development project. The orchestrator specifically controls these security scans based on the security tool configurations established in operation 1010.

The flowchart 1000 continues with operation 1030 to collect aggregated results from the security scans performed by the security tools. In some examples, this may include receiving notifications from the multiple security tools and polling results from the multiple security tools, generating the aggregated results based on the notifications and the polling results, and establishing a database of the aggregated results, as discussed above.

The flowchart 1000 continues with operation 1040 to output the aggregated results from the security scans in a graphical user interface. For instance, the aggregated results can include code vulnerabilities within the software development project that are identified by the security scans. The graphical user interface can include functionality as discussed above, such as to indicate multiple types, groups, or instances of code vulnerabilities identified from two or more of the multiple security tools.

In an example, the code vulnerabilities included in the aggregated results are prioritized based on analysis by a trained model, as discussed above. For example, the trained model can generate an assessment of priority based on application type, vulnerability type, and vulnerability severity.

The flowchart 1000 continues with an optional operation 1050 to update the security tool configurations, such as to incorporate additional or updated security tools that perform certain types of security scans, or to add or modify the use of particular security tools.

Additional operations (not depicted in the flowchart 1000) may include identifying an updated or new security tool to be integrated for the vulnerability identification in the software development project, and updating the security tool configurations (used in operation 1010) to include the updated or new security tool. Additional operations may also include generating automated tickets to address the code vulnerabilities found in the security scans performed by the multiple security tools, and tracking remediations of the automated tickets to address the code vulnerabilities. Vulnerability trends and remediation trends may be output in the graphical user interface, based on the code vulnerabilities and the remediations of the automated tickets.

In examples where multiple software development projects are managed in the security abstraction layer platform, the flowchart 1000 may also include operations for providing and coordinating multiple microservices and interfaces from the security abstraction layer platform. Multiple microservices and interfaces can be used to coordinate information between the multiple security tools and software development environments used with the multiple software development projects.

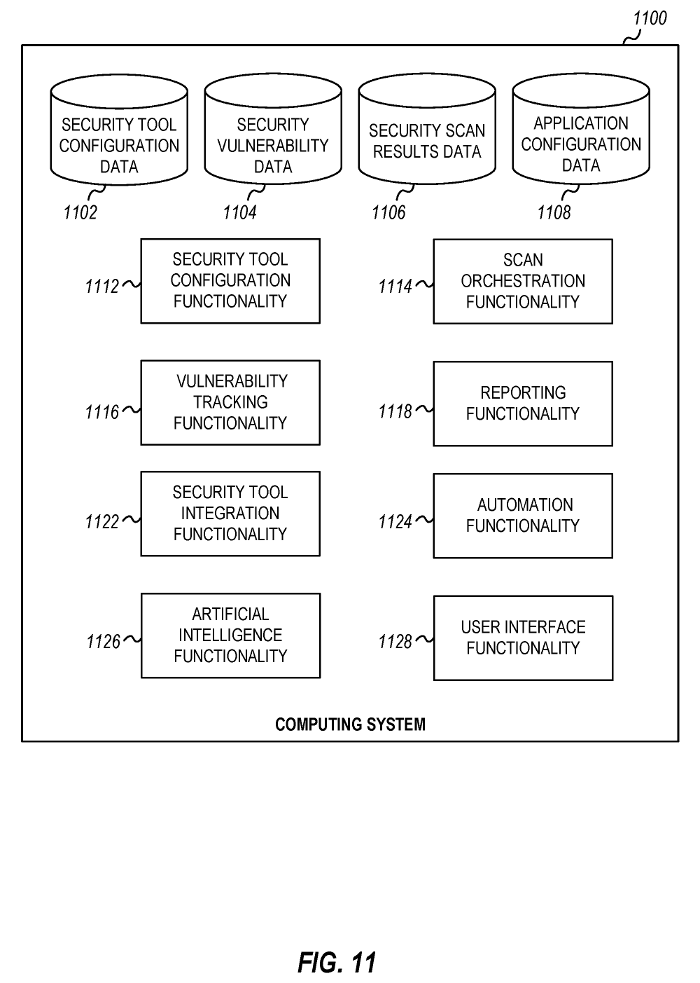

FIG. 11 illustrates a block diagram of hardware and functional components of a computing system 1100 to implement and support the security abstraction layer platform 210, and to perform the examples and use cases described above. It will be understood, that although certain hardware and functional components are depicted in FIG. 11 and in other drawings as separate subsystems or services, the features of the subsystems or services may be integrated into a single or combined system or service (e.g., accessible via an application programming interfaces hosted by a server computing system, or in a software package executable by a computing device). Further, although only one computing system is depicted, it will be understood that the features of these systems may be distributed among one or multiple computing systems (including in cloud-based processing settings).

As shown, the computing system 1100 includes various functionality subsystems 1112-1128 used to implement functionality of the security abstraction layer platform 210 (e.g., to provide the views and functions depicted in FIG. 3, operate the user interfaces of FIGS. 4 to 8, and data flows of FIGS. 9 and 10). The computing system 1100 also includes data stores (e.g., databases) of data 1102-1108 to store and access data that implements such functionality of the security abstraction layer platform 210.

The data maintained for the security abstraction layer platform 210 may include the following. First, the security tool configuration data 1102 is used to host configuration data associated with security testing tools. The security abstraction layer platform 210 manages and maintains the configurations required for running security scans across different tools, ensuring consistency and reducing the risk of misconfiguration.

Second, the security vulnerability data 1104 is used to host vulnerability data identified from security tools. The security abstraction layer platform 210 aggregates and stores vulnerability data collected from various security tools, enabling real-time analysis and prioritization of vulnerabilities.

Third, the security scan results data 1106 is used to host security scan results. The security abstraction layer platform 210 retains the results of security scans conducted by integrated security tools, providing a comprehensive view of the security posture of software development projects and deployed applications.

Fourth, the application configuration data 1108 is used to associate software applications with corresponding security tool configurations. The security abstraction layer platform 210 tracks metadata related to software development projects and deployed applications, such as configuration details and integration status, to facilitate seamless orchestration and management of security operations.

In an example, the computing system 1100 is adapted to execute respective software applications that implement the functionality subsystems and databases through multiple processing components and functionality, such as via circuitry and software instructions. In an example, the computing system 1100 is adapted to implement respective functional components including: security tool configuration functionality 1112 operable to establish and implement respective configurations for integration of security tools into code development projects; scan orchestration functionality 1114 operable to implement and control vulnerability scans from security tools performed on code development projects; vulnerability tracking functionality 1116 operable to collect and aggregate vulnerability information identified from the scans performed by the security tools; reporting functionality 1118 operable to create interactive reports of vulnerabilities, remediations, and configurations; security tool integration functionality 1122 operable to integrate new and updated security tools; automation functionality 1124 used to automate reporting, vulnerability ticketing, and vulnerability resolution; artificial intelligence functionality 1126 operable to prioritize scanning, reporting, ticketing, or remediation actions; and user interface functionality 1128 operable to present graphical user interfaces, command line interfaces, application programming interfaces, and related interfaces for operation of the security abstraction layer platform 210. Other functional and processing aspects may be performed or structurally embodied by the computing system 1100 (or coordinated computing systems or devices) to implement the techniques discussed above for FIGS. 1-10.

Embodiments used to facilitate and perform the techniques described herein may be implemented in one or a combination of hardware, firmware, or software. Embodiments may also be implemented as instructions stored on a machine-readable or computer-readable storage medium (e.g., a storage device), which may be read and executed by at least one processor to perform the operations described herein. A machine-readable storage medium may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

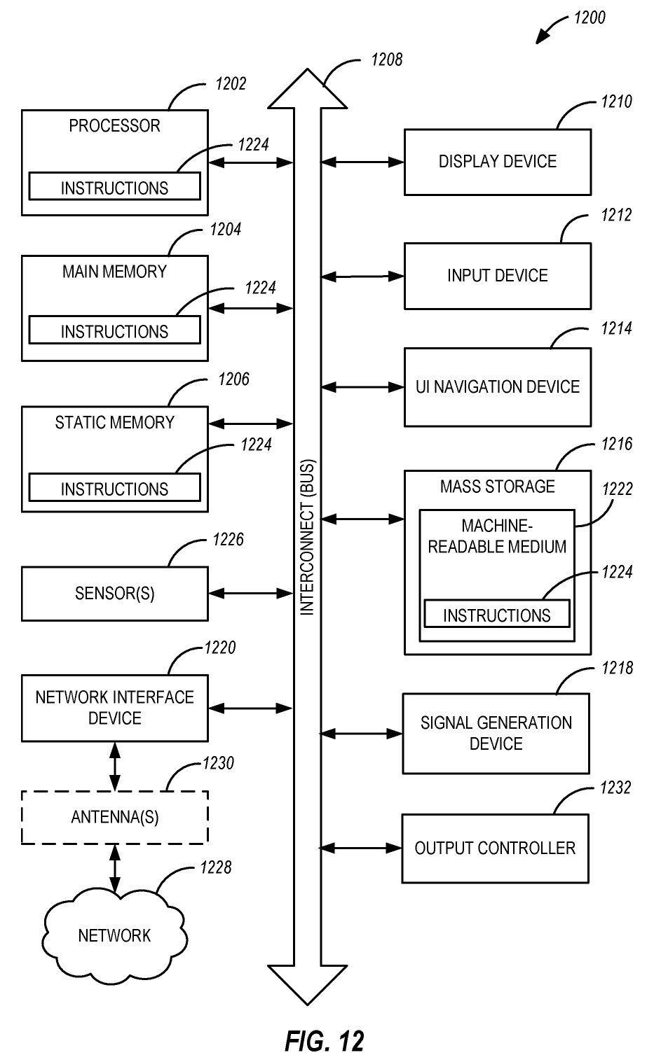

FIG. 12 illustrates a block diagram illustrating a machine in the example form of a computer system machine 1200, within which a set or sequence of instructions may be executed to cause the machine to perform any one of the methodologies discussed herein, according to an example. Computer system machine 1200 may be embodied by the computing system 1100; the subsystem(s) implementing the data stores for data 1102, 1104, 1106, 1108; the subsystem(s) implementing the various components or functionality 1112, 1114, 1116, 1118, 1122, 1124, 1126, 1128; the subsystem(s) implementing the platform 110, the platform 210, components 230, and user interfaces 410, 510, 610, 710, 810, 820; the computing devices such as mobile device 123, personal computer 124, or tablet 125; or any other electronic processing or computing platform described or referred to herein. Further, the computer system machine 1200 may embody instructions and data to perform any of the interfaces or functions referenced for FIGS. 1-11.

Example computer system machine 1200 includes at least one processor 1202 (e.g., a central processing unit (CPU), a graphics processing unit (GPU) or both, processor cores, compute nodes, etc.), a main memory 1204 and a static memory 1206, which communicate with each other via an interconnect 1208 (e.g., a link, a bus, etc.). The computer system machine 1200 may further include a video display unit 1210, an alphanumeric input device 1212 (e.g., a keyboard), and a user interface (UI) navigation device 1214 (e.g., a mouse). In one example, the video display unit 1210, input device 1212 and UI navigation device 1214 are incorporated into a touchscreen interface and touchscreen display. The computer system machine 1200 may additionally include a storage device 1216 (e.g., a drive unit), a signal generation device 1218 (e.g., a speaker), an output controller 1232, a network interface device 1220 (which may include or operably communicate with one or more antennas 1230, transceivers, or other wireless communications hardware), and one or more sensors 1226, such as a global positioning system (GPS) sensor, compass, accelerometer, location sensor, or other sensor.

The storage device 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204, static memory 1206, and/or within the processor 1202 during execution thereof by the computer system machine 1200, with the main memory 1204, static memory 1206, and the processor 1202 also constituting machine-readable media.

While the machine-readable medium 1222 is illustrated in an example to be a single medium, the term “machine-readable medium” may include a single medium or multiple media (e.g., a centralized or distributed database, and/or associated caches and servers) that store the one or more instructions 1224. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1224 may further be transmitted or received over a communications network 1228 using a transmission medium via the network interface device 1220 utilizing any one of a number of well-known transfer protocols (e.g., HTTP). Examples of communication networks include a local area network (LAN), a wide area network (WAN), the Internet, mobile and wired telephone networks, and wireless data networks (e.g., Wi-Fi, 3G, 4G LTE/LTE-A, 5G, or Satellite communication networks). The term “transmission medium” shall be taken to include any intangible medium that is capable of storing, encoding, or carrying instructions for execution by the machine, and includes digital or analog communications signals or other intangible medium to facilitate communication of such software.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 is a method for implementing a security abstraction layer platform for integration with a software development process, the method comprising operations executed using at least one processor of a computing device, and the operations comprising: establishing security tool configurations that integrate multiple security tools for vulnerability identification in a software development project, wherein the security tool configurations include configuration details to enable use of a respective security tool to evaluate a corresponding aspect of the software development project; operating an orchestrator to manage security scans performed by the multiple security tools on source code of the software development project, wherein the orchestrator controls the security scans based on the security tool configurations; collecting aggregated results from the security scans performed by the multiple security tools; and outputting the aggregated results from the security scans in a graphical user interface, wherein the aggregated results include code vulnerabilities identified by the security scans.

In Example 2, the subject matter of Example 1 optionally includes wherein the code vulnerabilities included in the aggregated results are prioritized based on analysis by a trained model, and wherein the trained model provides an assessment of priority based on application type, vulnerability type, and vulnerability severity.

In Example 3, the subject matter of any one or more of Examples 1–2 optionally include identifying an updated or new security tool to be integrated for the vulnerability identification in the software development project; and updating the security tool configurations to include the updated or new security tool.

In Example 4, the subject matter of any one or more of Examples 1–3 optionally include wherein the graphical user interface indicates the code vulnerabilities identified from two or more of the multiple security tools.

In Example 5, the subject matter of any one or more of Examples 1–4 optionally include wherein collecting the aggregated results from the security scans includes: receiving notifications from the multiple security tools and polling results from the multiple security tools; generating the aggregated results based on the notifications and the polling results; and establishing a database of the aggregated results.

In Example 6, the subject matter of any one or more of Examples 1–5 optionally include wherein the software development project is one of multiple software development projects managed in the security abstraction layer platform, and wherein the method further comprises: identifying characteristics of the multiple software development projects; and outputting the characteristics of the multiple software development projects in the graphical user interface.

In Example 7, the subject matter of Example 6 optionally includes the operations further comprising: providing multiple microservices and interfaces from the security abstraction layer platform, wherein the multiple microservices and interfaces coordinate information between the multiple security tools and software development environments used with the multiple software development projects.

In Example 8, the subject matter of any one or more of Examples 1–7 optionally include identifying that a particular security tool of the multiple security tools does not have a corresponding security tool configuration for the software development project; and updating the security tool configurations to include the particular security tool.

In Example 9, the subject matter of any one or more of Examples 1–8 optionally include generating automated tickets to address the code vulnerabilities found in the security scans performed by the multiple security tools; and tracking remediations of the automated tickets to address the code vulnerabilities.

In Example 10, the subject matter of Example 9 optionally includes outputting vulnerability trends and remediation trends in the graphical user interface, based on the code vulnerabilities and the remediations of the automated tickets.

Example 11 is a non-transitory computer-readable storage medium, the computer-readable storage medium comprising instructions that, when executed by processor circuitry and memory of a computing device, causes the computing device to perform the operations of any of Examples 1 to 10.

Example 12 is a computing device comprising a hardware processor and a memory, the memory storing instructions, which when executed by the hardware processor, cause the computing device to perform the operations of any of Examples 1 to 10.

Example 13 is a computing system comprising means to perform the operations of any of Examples 1 to 10.

Example 14 is an apparatus comprising means to implement of any of Examples 1 to 13.

Example 15 is a system to implement of any of Examples 1 to 13.

Additional examples of the presently described method, system, and device embodiments include the following configurations recited by the claims. Each of the examples in the claims may stand on its own, or may be combined in any permutation or combination with any one or more of the other examples provided below or throughout the present disclosure.

What is claimed is:

1. A method for implementing a security abstraction layer platform for integration with a software development process, the method comprising operations executed using at least one processor of a computing device, and the operations comprising:
establishing security tool configurations that integrate multiple security tools for vulnerability identification in a software development project, wherein the security tool configurations include configuration details to enable use of a respective security tool to evaluate a corresponding aspect of the software development project;
operating an orchestrator to manage security scans performed by the multiple security tools on source code of the software development project, wherein the orchestrator controls the security scans based on the security tool configurations;
collecting aggregated results from the security scans performed by the multiple security tools; and
outputting the aggregated results from the security scans in a graphical user interface, wherein the aggregated results include code vulnerabilities identified by the security scans.

2. The method of claim 1, wherein the code vulnerabilities included in the aggregated results are prioritized based on analysis by a trained model, and wherein the trained model provides an assessment of priority based on application type, vulnerability type, and vulnerability severity.

3. The method of claim 1, further comprising:
identifying an updated or new security tool to be integrated for the vulnerability identification in the software development project; and
updating the security tool configurations to include the updated or new security tool.

4. The method of claim 1, wherein the graphical user interface indicates the code vulnerabilities identified from two or more of the multiple security tools.

5. The method of claim 1, wherein collecting the aggregated results from the security scans includes:
receiving notifications from the multiple security tools and polling results from the multiple security tools;
generating the aggregated results based on the notifications and the polling results; and
establishing a database of the aggregated results.

6. The method of claim 1, wherein the software development project is one of multiple software development projects managed in the security abstraction layer platform, and wherein the method further comprises:
identifying characteristics of the multiple software development projects; and
outputting the characteristics of the multiple software development projects in the graphical user interface.

7. The method of claim 6, the operations further comprising:
providing multiple microservices and interfaces from the security abstraction layer platform, wherein the multiple microservices and interfaces coordinate information between the multiple security tools and software development environments used with the multiple software development projects.

8. The method of claim 1, further comprising:
identifying that a particular security tool of the multiple security tools does not have a corresponding security tool configuration for the software development project; and
updating the security tool configurations to include the particular security tool.

9. The method of claim 1, further comprising:
generating automated tickets to address the code vulnerabilities found in the security scans performed by the multiple security tools; and
tracking remediations of the automated tickets to address the code vulnerabilities.

10. The method of claim 9, further comprising:
outputting vulnerability trends and remediation trends in the graphical user interface, based on the code vulnerabilities and the remediations of the automated tickets.

11. A non-transitory computer-readable storage medium, the computer-readable storage medium comprising instructions that, when executed by processor circuitry of a computing device, causes the computing device to implement a security abstraction layer platform for integration with a software development process, with operations that:
establish security tool configurations that integrate multiple security tools for vulnerability identification in a software development project, wherein the security tool configurations include configuration details to enable use of a respective security tool to evaluate a corresponding aspect of the software development project;
operate an orchestrator to manage security scans performed by the multiple security tools on source code of the software development project, wherein the orchestrator controls the security scans based on the security tool configurations;
collect aggregated results from the security scans performed by the multiple security tools; and
output the aggregated results from the security scans in a graphical user interface, wherein the aggregated results include code vulnerabilities identified by the security scans.

12. The computer-readable storage medium of claim 11, wherein the code vulnerabilities included in the aggregated results are prioritized based on analysis by a trained model, and wherein the trained model provides an assessment of priority based on application type, vulnerability type, and vulnerability severity.

13. The computer-readable storage medium of claim 11, wherein the instructions further cause the computing device to perform operations that:
identify an updated or new security tool to be integrated for the vulnerability identification in the software development project; and
update the security tool configurations to include the updated or new security tool.

14. The computer-readable storage medium of claim 11, wherein the graphical user interface indicates the code vulnerabilities identified from two or more of the multiple security tools.

15. The computer-readable storage medium of claim 11, wherein to collect the aggregated results from the security scans includes to:
receive notifications from the multiple security tools and polling results from the multiple security tools;
generate the aggregated results based on the notifications and the polling results; and
establish a database of the aggregated results.

16. The computer-readable storage medium of claim 11, wherein the software development project is one of multiple software development projects managed in the security abstraction layer platform, and wherein the instructions further cause the computing device to perform operations that:
identify characteristics of the multiple software development projects; and
output the characteristics of the multiple software development projects in the graphical user interface.

17. The computer-readable storage medium of claim 16, wherein the instructions further cause the computing device to perform operations that:
provide multiple microservices and interfaces from the security abstraction layer platform, wherein the multiple microservices and interfaces coordinate information between the multiple security tools and software development environments used with the multiple software development projects.

18. The computer-readable storage medium of claim 11, wherein the instructions further cause the computing device to perform operations that:
identify that a particular security tool of the multiple security tools does not have a corresponding security tool configuration for the software development project; and
update the security tool configurations to include the particular security tool.

19. The computer-readable storage medium of claim 11, wherein the instructions further cause the computing device to perform operations that:
generate automated tickets to address the code vulnerabilities found in the security scans performed by the multiple security tools; and
track remediations of the automated tickets to address the code vulnerabilities.

20. The computer-readable storage medium of claim 19, wherein the instructions further cause the computing device to perform operations that:
output vulnerability trends and remediation trends in the graphical user interface, based on the code vulnerabilities and the remediations of the automated tickets.
